(19) United States
(12) Patent Application Publication
(10) Pub. No.: US 2014/0369625 A1
(43) Pub. Date: Dec. 18, 2014

(54) IMAGE PROCESSING METHOD

(71) Applicant: ASUSTeK COMPUTER INC., Taipei (TW)

(72) Inventors: Shih-Chi LIN, Taipei (TW); Tai-Ming PARNG, Taipei (TW)

(21) Appl. No.: 14/307,484

(22) Filed: Jun. 17, 2014

Related U.S. Application Data
(60) Provisional application No. 61/836,649, filed on Jun. 18, 2013.

(30) Foreign Application Priority Data
May 15, 2014 (CN) 201410205894.8

(51) Int. Cl. G06T 5/00

(52) U.S. Cl. CPC G06T 5/006
USPC 382/275

(57) ABSTRACT

An image processing method applied to an image processing device, the image processing method includes following steps: receiving an original wide-angle image, pre-processing the original wide-angle image and capturing at least a region of interesting (ROI); executing anti-distorting processing on the ROI to generate a local correction image; and executing image processing on the local correction image. In the image processing method, parts of ROI of the original wide-angle image is captured, anti-distorting processing and image processing are executed, which significantly improves the image processing efficiency and reduces the time consumption instead of executing anti-distorting processing on the ROI directly.

### CROSS-REFERENCE TO RELATED APPLICATION

This application claims the priority benefit of CN application serial No. 201410205894,8, tiled on May 15, 2014 and U.S. provisional application Ser. No. 61/836,649, filed on Jun. 18, 2013. The entirety of the above-mentioned patent application is hereby incorporated by reference herein and made a part of specification.

### BACKGROUND OF THE INVENTION

1. Field of the Invention

The invention relates to an image processing method and, more particularly, to a wide-angle image processing method.

2. Description of the Related Art

The view angle of a conventional camera is usually between 60 degree and 90 degree, and thus the captured image information is limited. In contrast, a super wide lens (such as fish-eye lens) can capture as wide-angle image coving a wide view range. However, since the view angle of the super wide lens can be broadened to 360 degree multiplied by 180 degree, the captured wide-angle image is usually distorted. Therefore, panoramic correcting should be executed on the captured wide-angle image before further image processing. A huge calculation is needed in correcting a conventional wide-angle image, and the subsequent image processing is also a complicated algorithm. Consequently, the efficiency of the image processing calculation on the corrected panoramic image is rather low.

### BRIEF SUMMARY OF THE INVENTION

An image processing method applied, to an image processing device is provided. The image processing method includes following steps: receiving an original wide-angle image by a pre-processing module, and pre-processing the original wide-angle image and capturing at least a region of interesting (ROI); executing anti-distorting processing on the ROI by an image correction module to generate a local correction image; and executing image processing on the local correction image by an image processing module.

In the image processing method, parts of the ROI of the original wide-angle image is captured, the anti-distorting processing and image processing are executed, which significantly improves the image processing efficiency and reduces the time consumption instead of executing anti-distorting processing on the ROI directly.

### BRIEF DESCRIPTION OF THE DRAWINGS

FIG 1 is a block diagram showing an image processing device in an embodiment; and

FIG. 2 is a flow chart showing an image processing method in an embodiment.

### DETAILED DESCRIPTION OF THE EMBODIMENTS

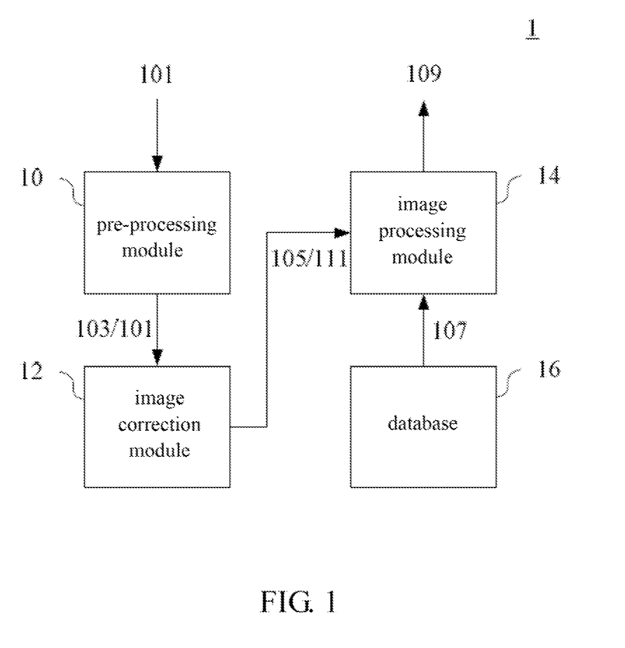

As shown in FIG. 1, FIG. 1 is a block diagram showing an image processing device in an embodiment image processing. An image processing device 1 includes a pre-processing module 10, an image correction module 12, an image processing module 14 and a database 16.

The pre-processing module 10 receives an original wide-angle image 101 and has a pre-processing to capture at least a region of interesting (ROI) 103. The original wide-angle image 101 is captured by a bug-eye lens, which is not limited here. In an embodiment, the original wide-angle image 101 has image information of 360 degree multiplied by 180 degree. The original wide-angle image 101 is a distortion image due to the view angle.

In an embodiment, the pre-processing module 10 searches a plurality of characteristic points of the original wide-angle image 101, and captures at least one region as the ROI 103, and the density of the characteristic points in the ROI exceeds a threshold value. These characteristic points locate at a boundary or a texture of the original wide-angle image 101.

In an embodiment, pixels whose color or grayscale value are obviously different are searched from the original wide-angle image 101 as the characteristic points via an edge detection. In other embodiment, the characteristic points can be searched by other technologies, which is not limited herein.

The pre-processing module 10 captures a region as the ROI 103 when the pre-processing module 10 determines that the density of characteristic points in the region of the original wide-angle image 101 exceeds the threshold value. In different embodiments, the pre-processing module 10 captures all regions conforming the condition as the ROI 103, or captures the region with the characteristic points of the greatest value density or the largest size as the ROI 103 to have a subsequent processing.

In another embodiment, the pre-processing module 10 recognizes the color or the grayscale value of the original wide-angle image 101, and it captures at least a region having similar color or similar grayscale value as the ROI 103. In different embodiments, the pre-processing module 10 captures all regions conforming the condition as the ROI 103, or captures the region with the largest size as the ROI 103 to have a subsequent processing.

In another embodiment, the pre-processing module 10 recognizes at least a moving region of the original wide-angle image 101 as the ROI 103. In an embodiment, the pre-processing module 10 compares the original wide-angle image 101 with the image captured at a previous time point to recognize the moving region in the original wide-angle image 101 via a motion detection technology, which is not limited herein. In different embodiments, the pre-processing module 10 captures all regions conforming the condition as the ROI 103, or captures the region with the largest size as the ROI 103 to have a subsequent processing.

In an embodiment, the pre-processing module 10 can capture different types of RIO 103 by using at least two of the following methods, such as searching characteristic point, identifying color or grayscale value, and identifying a moving region. In an embodiment, the pre-processing module 10 executes erosion or dilation on the ROI 103 to eliminate the noise, but the pre-processing method is not limited to the erosion or the dilation herein.

After the ROT 103 is captured, the image correction module 12 has an anti-distorting processing on the ROI 103 to generate a local correction image 105. In an embodiment, the mage correction module 12 can make the distorted ROI 103 stretched to a flat image by the anti-distorting processing according to the position of the ROI 103 in the original wide-angle image 101. The anti-distorting processing may be executed according to the angle or the distance relative to the center or a side, which is not limited herein.

The image processing module 14 compares the local correction image 105 with data 107 in the database 16 to have scene recognition, human recognition, object recognition or their combination and generate a recognized result 109.

For example, when the pre-processing module 10 captures a region with an scene object (such as a building region) according to the characteristic points, after the image correction module 12 executes the anti-distorting processing, the processed region can be compared with the scene data stored in the database 16 (which is not shown in the figures) to determine what is the building, and further determines that the original wide-angle image 101 is the scene surrounding a specific building.

In an embodiment, the scene recognition is achieved by the processing on different brightness, and the processing includes standardization, feature extraction, clustering and voting according to a database, descriptor matching and geometry validity or the combination of them, which is not limited herein.

Similarly, the skin color region in the original wide-angle image 101 is recognized by the pre-processing module 10, such as via skin filter technology, and the image correction module 12 has an anti-distorting processing on the skin color region to generate a local correction image 105. Then, the image processing module 14 compares the local correction image 105 with the face data (which is not shown in figures) stored in the database 16 to determine whether the skin color region is a face and a person corresponding the face, so as to achieve human recognition.

In an embodiment, the moving region in the original wide-angle image 101 is recognized by the pre-processing module 10, and the image correction module 12 has an anti-distorting processed on the moving region to generate a local correction image 105. Then, the image processing module 14 compares the local correction image 105 with person or the face data (not shown in figures) stored in the database 16 to determine whether the moving region is a figure and a person or a face corresponding a figure, so as to achieve human recognition.

Similarly, the object recognition also may be achieved by the above method, which is not limited herein.

As described above, in some embodiments, the pre-processing module 10 captures all regions which meet the requirement on the density of characteristic points, color, grayscale value or the moving region as the ROI 103, and the ROI 103 is processed by the image correction module 12 and the image processing module 14.

In some embodiments, the pre-processing module 10 only captures the region with highest density or largest size area from the regions meeting one or a combination of the conditions to regard as the ROI 103, and a subsequent processing is processed. If the image processing module 14 fails to recognize the region, the pre-processing module 10 captures the secondary greatest value density or the secondary largest size area from the region meeting the condition as the ROI 103, and the ROI 103 is processed by the image correction module 12 and the image processing module 14 until the recognition is successfully recognized or all regions meeting the condition are processed completely.

In an embodiment, when the image processing module 14 recognizes a matching scene, a matching person or a matching object, the corresponding number in the database is feedbacked to confirm that the recognition is successful.

When the pre-processing module 10 fails to capture any ROI 103, such as there is no obvious object edge or skin color region to capture. An image correction module 12 can directly have the anti-distorting processing on the original wide-angle image 101 to generate a panoramic correction image 111, and the panoramic correction image 111 is processed by the image processing module 14.

The wide-angle image processing device 1 can only capture part of the ROI 103 from the original wide-angle image 101 to have the anti-distorting processing and image processing, instead the processing on the whole original wide-angle image 101. As a result, the wide-angle image processing device 1 significantly improves the image processing efficiency and reduces the time consumption.

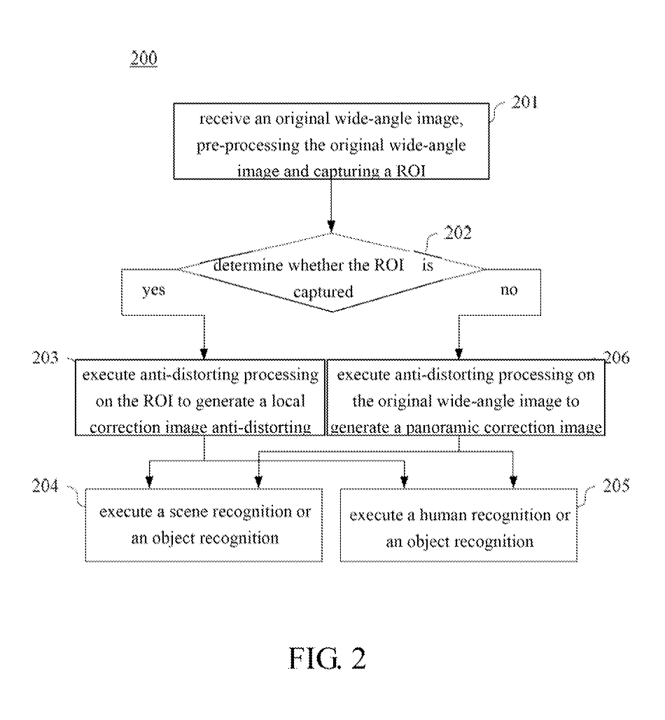

As shown in FIG. 2, FIG. 2 is a flow chart showing an image processing method in an embodiment. The image processing method 200 can be applied to the image processing device 1 as shown in FIG 1. The image processing 200 includes following steps.

In a step 201, a pre-processing module 10 receives an original wide-angle image 101 and has a pre-processing to capture a ROI 103.

In a step 202, the pre-processing module 10 determines that whether the ROI 103 is captured.

After the pre-processing module 10 captures the ROI 103, in step 203, the image correction module 12 has the anti-distorting processing on the ROI 103 to generate a local correction image 105.

In a step 204, the image processing module 14 has a scene or an object recognition on the local correction image 105, or in a step 205, the image processing module 14 has a human recognition or an object recognition on the local correction image 105.

In the step 202, if the pre-processing module 10 fails to capture the ROI 103, then, in step 206, the image correction module 12 has the anti-distorting processing on the original wide-angle image 101 to generate a panoramic correction image 111. Then, in step 204 or step 205, the image processing module 14 has a scene recognition, human recognition or object recognition of the panoramic correction image 111.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An image processing method, applied to an image processing device, the image processing method comprising following steps:
receiving an original wide-angle image, pre-processing the original wide-angle image and capturing at least a region of interesting (ROI);
executing anti-distorting processing on the ROI to generate a local correction image; and
executing image processing on the local correction image.

2. The image processing method according to claim 1, wherein the pre-processing further includes:
searching a plurality of characteristic points of the original wide-angle image; and
capturing at least one region as the ROI, wherein the density of the characteristic points of the region exceeds a threshold value.

3. The image processing method according to claim 2, wherein the characteristic points locates at at least one boundary or at least a texture of the original wide-angle image.

4. The image processing method according to claim 1, wherein the pre-processing further includes:
recognizing color or grayscale value of the original wide-angle image, and
capturing at least one region having similar color or similar gray scale as the ROI.

5. The image processing method according to claim 1, wherein the pre-processing further includes;
recognizing at least one moving region of the original wide-angle image as the ROI.

6. The image processing method according to claim 1, wherein the image processing further includes:
comparing the local correction image with a database to have one or a combination of scene recognition, human recognition, object recognition.

7. The image processing method according to claim 1, wherein the image processing method further includes:
executing anti-distorting processing on the original wide-angle image to generate a panoramic correction image when the ROI fails to be captured; and
executing image processing on the panoramic correction image.
